(19) United States
(12) Patent Application Publication
(10) Pub. No.: US 2019/0272068 A1
(43) Pub. Date: Sep. 5, 2019

(54) DISPENSER CONTROL USER INTERFACE

(71) Applicant: THE COCA-COLA COMPANY, Atlanta, GA (US)

(72) Inventors: David R. NEWMAN, Atlanta, GA (US); Charles Bradley GREEN, Atlanta, GA (US); J. Ryan EDER, Columbus, OH (US); Brandon EDER, Columbus, OH (US); Edward Michael GANDELMAN, Columbus, OH (US); Harlan Charles PEDEN, III, Sunbury, OH (US); Matthew Edward O'KELLY, Dublin, OH (US); Kris TOMASSON, Atlanta, GA (US)

(73) Assignee: THE COCA-COLA COMPANY, Atlanta, GA (US)

(21) Appl. No.: 16/308,624

(22) PCT Filed: Jun. 7, 2017
(86) PCT No.: PCT/US2017/036405

§ 371 Date: Dec. 10, 2018

Related U.S. Application Data
(60) Provisional application No. 62/348,254, filed on Jun. 10, 2016.

(51) Int. Cl. G06F 3/0482; G06F 3/0362; G06F 3/0354; G06F 3/0488; B67D 1/08; G07F 13/06

(52) U.S. Cl. CPC G06F 3/0482; G06F 3/0362; G06F 3/03547; B67D 1/0021; B67D 1/0888; G07F 13/065; G06F 2203/0339; G06F 3/04883

(57) ABSTRACT

A control interface for controlling the operation of a dispensing device may be provided. The control interface may include a display screen for individually presenting each of multiple options that may be utilized for controlling various operations associated with the dispensing device. The control interface may further include a navigation control, in communication with the display screen, which may be utilized to individually navigate through each of the options on the display screen. The display screen may be actuated to select a displayed option that is associated with performing a dispensing device operation.

This application is being filed on 7 Jun. 2017, as a PCT International Patent application and claims the benefit of priority to U.S. Provisional patent application Ser. No. 62/348,254, filed Jun. 10, 2016, the entire disclosure of which is incorporated by reference in its entirety.

### BACKGROUND

Modern dispensing devices include functionality for consumers and/or customers to select from a menu of available products and to access device functions on a device display screen. Typically, the consumer is presented with a global list of products (e.g., beverages) for purchase or dispense via the display screen. Similarly, a customer may be presented with a global list of device management functions via the same display screen. Current dispensing devices however, require a large footprint (for displaying the aforementioned products and management functions in various menus) that is typically not practical for smaller devices (e.g., in-home or small store dispensers), which have limited space requirements.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for controlling the operation of a dispensing device utilizing a control interface. The control interface may include a display screen for individually presenting each of multiple options that may be utilized for controlling various operations associated with the dispensing device. The control interface may further include a navigation control, in communication with the display screen, which may be utilized to individually navigate through each of the options on the display screen. The display screen may be actuated to select a displayed option that may be associated with performing a dispensing device operation. The foregoing general description and the following detailed description are illustrative only and are not restrictive of the embodiments as claimed.

### DESCRIPTION OF THE DRAWINGS

FIG. 1 is a block diagram illustrating a system architecture for providing a dispenser control user interface on a dispensing device, in accordance with some embodiments;

FIG. 2A shows a control interface displaying a dispenser control menu, in accordance with some embodiments;

FIG. 2B shows a control interface displaying a dispenser control menu, in accordance with some embodiments;

FIG. 2C shows a control interface displaying a dispenser control menu, in accordance with some embodiments;

FIG. 3A shows a control interface displaying an option for selecting a product available for dispense on the dispensing device, in accordance with some embodiments;

FIG. 3B shows a control interface displaying an option for initializing a dispensing device, in accordance with some embodiments;

FIG. 3C shows a control interface displaying an option for initiating a change out of a product brand in a dispensing device, in accordance with some embodiments;

FIG. 3D shows a control interface displaying an option for replacing a product ingredient package in a dispensing device, in accordance with some embodiments;

FIG. 3E shows a control interface displaying an option for accessing a dispensing device utilities menu, in accordance with some embodiments;

FIG. 4 shows a control interface for selecting from among a number of available products in a dispensing device for dispense, in accordance with some embodiments;

FIG. 5 shows various alerts that may be generated by a dispenser control interface, in accordance with some embodiments;

FIGS. 6A-6D shows a control interface being utilized to perform a product change out in a dispensing device, in accordance with some embodiments;

FIG. 7 is a flow diagram illustrating a routine for controlling a dispensing device utilizing a control interface, in accordance with some embodiments; and

FIG. 8 is a block diagram of a dispensing device with which some embodiments may be practiced.

FIG. 9 shows another example dispensing device.

FIG. 10 shows another view of the dispensing device of FIG. 9.

FIG. 11 shows a portion of the dispensing device of FIG. 9 including an example navigation control.

FIG. 12 shows another view of the navigation control of the dispensing device of FIG. 11.

FIG. 13 shows another view of the navigation control of the dispensing device of FIG. 11.

FIG. 14 shows another example navigation control for the dispensing device of FIG. 9.

FIG. 15 shows another example navigation control for the dispensing device of FIG. 9.

FIG. 16 shows another example navigation control for the dispensing device of FIG. 9.

FIG. 17 shows another example navigation control for the dispensing device of FIG. 9 used to select a brand of a beverage for pouring.

FIG. 18 shows another view of the navigation control of FIG. 17 used to select a sub-brand for pouring.

FIG. 19 shows another view of the navigation control of FIG. 18 after selection of the beverage for pouring.

FIG. 20 shows another view of the navigation control of FIG. 17 used to select a setting for the dispensing device.

FIG. 21 shows another view of the navigation control of FIG. 20 used to toggle the setting for the dispensing device.

FIG. 22 shows another example navigation control for the dispensing device of FIG. 9 used to select a brand of a beverage for pouring.

FIG. 23 shows an example method of use for the dispensing device of FIG. 9.

### DETAILED DESCRIPTION

Embodiments are provided for controlling the operation of a dispensing device utilizing a control interface. The control interface may include a display screen for individually presenting each of multiple options that may be utilized for controlling various operations associated with the dispensing device. The control interface may further include a navigation control, in communication with the display screen, which may be utilized to individually navigate through each of the options on the display screen. The display screen may be actuated to select a displayed option that may be associated with performing a dispensing device operation.

In the following detailed description, references are made to the accompanying drawings that form a part hereof, and in which are shown by way of illustrations specific embodiments or examples. These embodiments may be combined, other embodiments may be utilized, and structural changes may be made. The following detailed description is therefore not to be taken in a limiting sense, and the scope of the embodiments described herein is defined by the appended claims and their equivalents.

The term “beverage,” as used herein, may include, but is not limited to, pulp and pulp-free citrus and non-citrus fruit juices, fruit drink, vegetable juice, vegetable drink, milk, soy milk, protein drink, soy-enhanced drink, tea, water, isotonic drink, vitamin-enhanced water, soft drink, flavored water, energy drink, coffee, smoothies, yogurt drinks, hot chocolate and combinations thereof. The beverage may also be carbonated or non-carbonated. The beverage may comprise beverage components (e.g., beverage bases, colorants, flavorants, and additives).

The term “beverage base” may refer to parts of the beverage or the beverage itself prior to additional colorants, additional flavorants, and/or additional additives. According to some embodiments, beverage bases may include, but are not limited to syrups, concentrates, and the like that may be mixed with a diluent such as still or carbonated water or other diluent to form a beverage. The beverage bases may have reconstitution ratios of about 3:1 to about 6:1 or higher. According to some embodiments, beverage bases may comprise a mixture of beverage base components.

The term “beverage base component” may refer to components that may be included in beverage bases. According to some embodiments, the beverage base component may comprise parts of beverages that may be considered food items by themselves. According to some embodiments, the beverage base components may be micro-ingredients such as an acid portion of a beverage base; an acid-degradable and/or non-acid portion of a beverage base; natural and artificial flavors; flavor additives; natural and artificial colors; nutritive or non-nutritive natural or artificial sweeteners; additives for controlling tartness, e.g., citric acid, potassium citrate; functional additives such as vitamins, minerals, or herbal extracts; nutraceuticals; or medicaments. The micro-ingredients may have reconstitution ratios from about 10:1, 20:1, 30:1, or higher with many having reconstitution ratios of 50:1 to 300:1. The viscosities of the micro-ingredients may range from about 1 to about 100 centipoise.

Thus, for the purposes of requesting, selecting, or dispensing a beverage base, a beverage base formed from separately stored beverage base components may be equivalent to a separately stored beverage base. For the purposes of requesting, selecting or dispensing a beverage, a beverage formed from separately stored beverage components may be equivalent to a separately stored beverage.

By “separately stored” it is meant that the components of the present invention are kept separate until combined. For instance, the components may be separately stored individually in each container or may be all stored in one container wherein each component is individually packaged (e.g., plastic bags) so that they do not blend while in the container. In some embodiments, the container, itself, may be individual, adjacent to, or attached to another container.

The term “blended beverage” may include final products wherein two or more beverages have been blended or mixed or otherwise combined to form a final product.

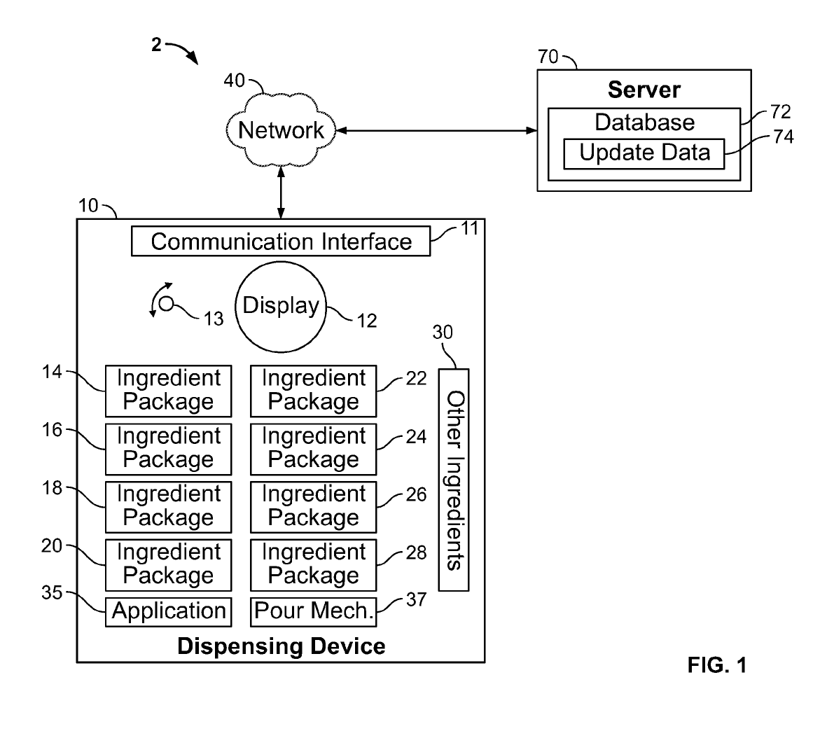

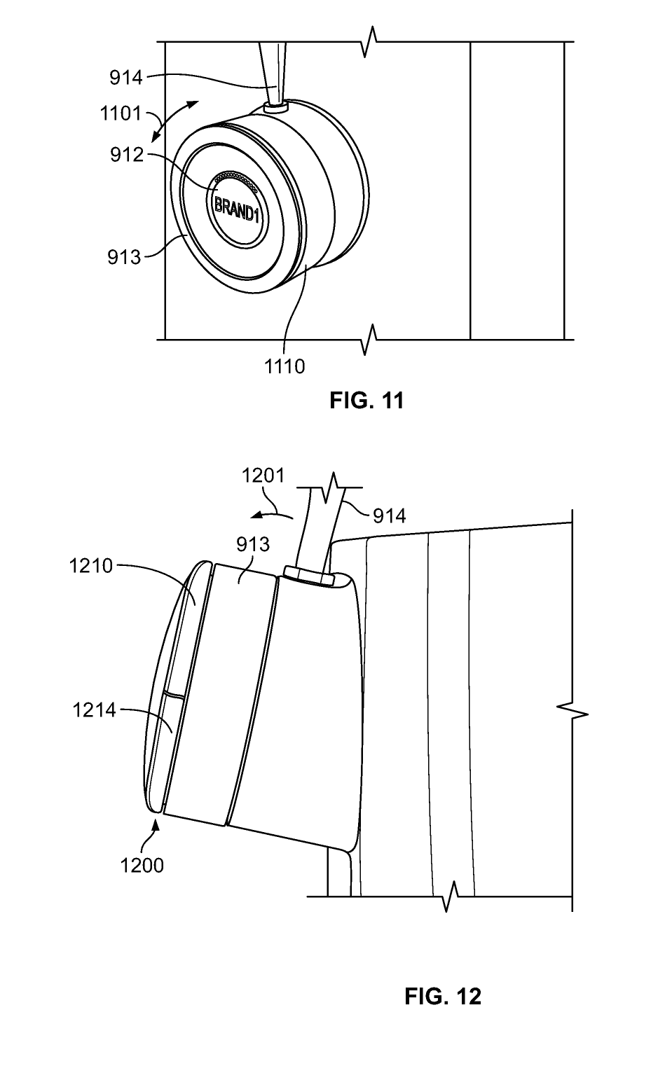

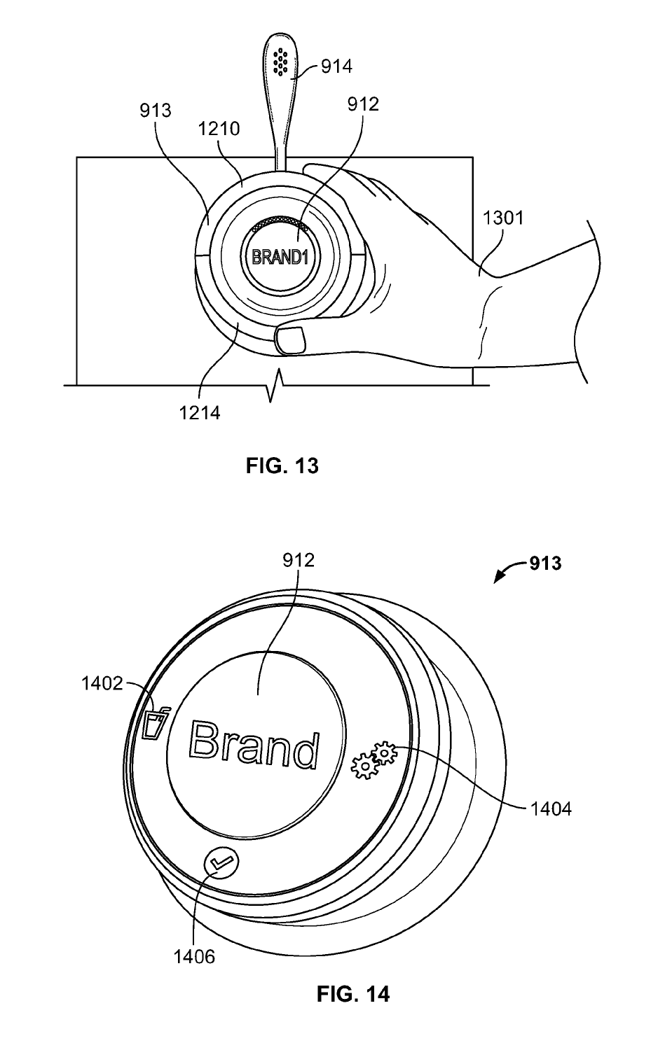

Referring now to the drawings, in which like numerals represent like elements through the several Figures, various aspects of the present invention will be described. FIG. 1 is a block diagram illustrating a system architecture 2 for providing a dispenser control user interface on a dispensing device, in accordance with some embodiments. The system architecture 2 may include a dispensing device 10. The dispensing device 10 may include a communication interface 11 and a control interface that may comprise a selectable display screen 12 and a navigation control 13. In some embodiments, the display screen 12 may include a mechanical switch that enables the display screen 12 to be actuated for selecting options associated with operating the dispensing device 10. In some embodiments, the selectable display screen 12 may comprise a touch interface that may be actuated for selecting options associated with operating the dispensing device 10. The selected operations may include, but are not limited to, individually selecting and/or dispensing one or more products (e.g. beverage products), dispensing device initialization, product change out, product replacement and accessing a utilities menu (e.g., for dispensing device calibration, setting a clock/calendar, connecting to Wi-Fi, retrieving software updates, etc.). The navigation control 13 may comprise a rotary user control for individually navigating (i.e., scrolling or dialing) among various selectable options on the display screen 12. In some embodiments, the navigation control 13 may comprise a physical control knob that may be rotated in both clockwise and counter-clockwise directions to individually view the aforementioned options for operating the dispensing device 10 on the display screen 12. See FIGS. 9-22 described below. In some embodiments, the navigation control 13 may comprise a touch interface that may be selected by the user to individually navigate among various selectable options on the display screen 12. Other types of interfaces may also be utilized for the navigation control 13.

The dispensing device 10 may also include ingredient packages (or pouches) 14, 16, 18, 20, 22, 24, 26 and 28. In some embodiments, the ingredient packages 14, 16, 18 and 20 may comprise various beverage bases or beverage base components such as beverage bases. In some embodiments, the ingredient packages 22, 24, 26, and 28 may comprise flavors (i.e., flavoring agents, flavor concentrates, or flavor syrups). In some embodiments, the beverage bases in the ingredient packages 14, 16, 18, and 20 may be concentrated syrups. In some embodiments, the beverage bases in the ingredient packages 14, 16, 18 and 20 may be replaced with or additionally provided with beverage base components. In some embodiments, each of the beverage bases or beverage base components in the ingredient packages and each of the flavors in the ingredient packages 22, 24, 26 and 28 may be separately stored or otherwise contained in individual removable cartridges that are stored in the dispensing device 10. The dispensing device 10 may automatically identify the cartridges upon installation by a user or the user may be prompted to identify the cartridges when they are installed. The aforementioned beverage components (i.e., beverage bases or beverage base components and flavors) may be combined, along with other beverage ingredients 30, to dispense various beverages or blended beverages (i.e., finished beverage products) from the dispensing device 10. It should be understood however, that the dispensing device 10 may also be configured to dispense beverage components individually. In some embodiments, the dispensing device 10 may be configured to dispense beverage base components so as to form a beverage base. The other beverage ingredients 30 may include diluents such as still, sparkling, or carbonated water, functional additives, or medicaments, for example. The other beverage ingredients 30 may be installed in the dispensing device 10, pumped to the dispensing device 10, or both. The carbonated water may be produced in the dispensing device 10 through mixing of CO₂ and still water such as in a carbonator or other device that produces carbonated water. The dispensing device 10 may also include an application 35 that may be configured to control various operations of the dispensing device 10 including enabling use of a control interface view and the selection of multiple dispenser options associated with selecting and dispensing products (e.g., beverage products) as well as other dispensing device functions. The dispensing device 10 may also include a pour mechanism 37 for dispensing various beverages or blended beverages.

In some embodiments, the dispensing device 10 may comprise a self-contained beverage dispenser for in-home use or for use by small business enterprises. For example, the dispensing device 10 may have a small footprint for placement on a kitchen countertop or similar surface and further include a small display screen having a limited area for viewing various product options and device functions by the user. The dispensing device 10 may further include a separate reservoir (not shown) for receiving ice and water for use in dispensing beverages. As another example, the dispensing device 10 may be plumbed such that it may be connected to a water line and further include a refrigeration deck (not shown) for cooling beverages. The dispensing device 10 may further include other types of product dispensers in accordance with some embodiments.

The dispensing device 10 may also be in communication with a server 70 over a network 40 that may include a local network or a wide area network (e.g., the Internet). In some embodiments, the communication between the dispensing device 10 and the server 70 may be accomplished utilizing any number of communication techniques including, but not limited to, BLUETOOTH wireless technology, Wi-Fi and other wireless or wireline communication standards or technologies, via the communication interface 11. The server 70 may include a database 72 that may store update data 74 associated with the dispensing device 10. In some embodiments, the update data 74 may comprise a software update for the application 35 on the dispensing device 10.

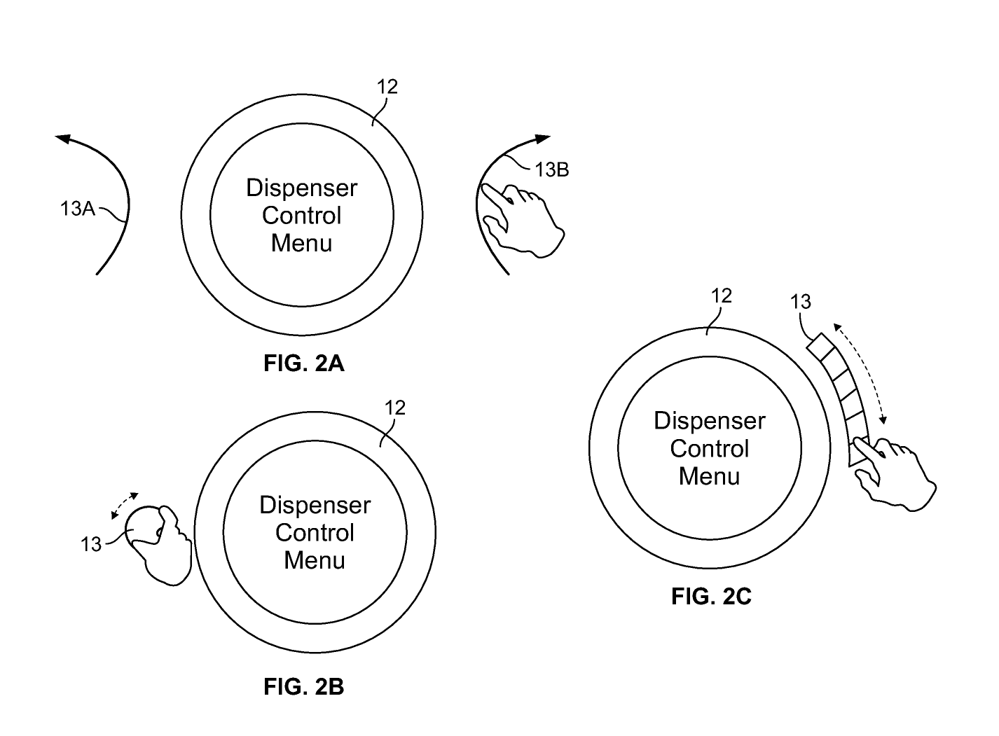

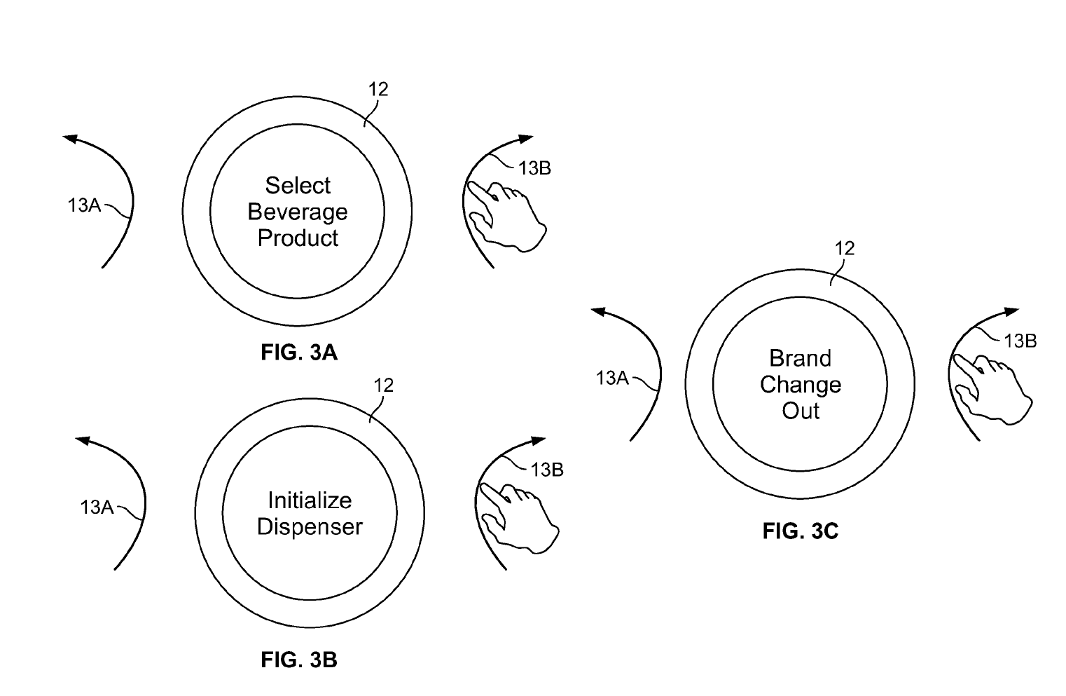

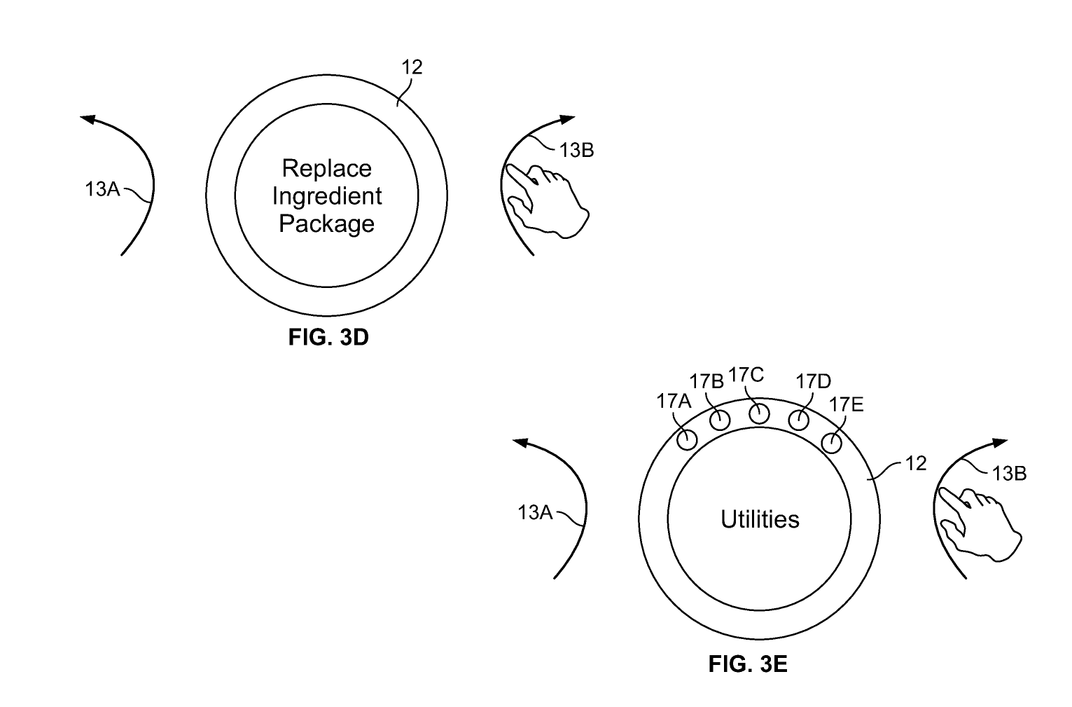

FIG. 2A shows a control interface displaying a dispenser control menu, in accordance with some embodiments. The control interface of FIG. 2A may include the display screen 12 and navigation controls 13A and 13B. In some embodiments, the navigation controls 13A and 13B may comprise touch interfaces that may be selected by the user to scroll through menu options, which may be individually shown in the display screen 12, in left and right directions. The display screen 12 shows a dispenser control menu that, in some embodiments, may comprise a main menu that may be displayed upon a startup of the dispensing device 10. In some embodiments, the dispenser control menu may comprise an initialization menu for accessing options to initialize the dispensing device 10 to dispense various beverage products as well as setup language, calendar, clock, and Wi-Fi functionality associated with the dispensing device 10. In some embodiments, the dispenser control menu may comprise a product dispense menu for selecting available beverage products for dispense from the dispensing device 10. Other menu types for the dispenser control menu may also be utilized in some embodiments. The navigation controls 13A and 13B may be utilized to scroll from the main menu through a series of sub-menus that may display options associated with dispensing device operations. Examples of sub-menus that may be accessed from the dispenser control menu shown in FIG. 2A will be described in greater detail below with respect to FIGS. 3A-3E.

FIG. 2B shows a control interface displaying a dispenser control menu, in accordance with some embodiments. The control interface of FIG. 2B may include the display screen 12 and navigation control 13. In some embodiments, the navigation control 13 may comprise a physical control knob that may be selected by the user to scroll through menu options, which may be individually shown in the display screen 12, in both clockwise and counter-clockwise directions.

FIG. 2C shows a control interface displaying a dispenser control menu, in accordance with some embodiments. The control interface of FIG. 2C may include the display screen 12 and navigation control 13. In some embodiments, the navigation control 13 may comprise an illuminated touch interface that may include a capacitive sensor for sensing a touch input. The touch interface that may be selected by the user to scroll through menu options, that may be individually shown in the display screen 12, by engaging the touch interface in either a generally upward or generally downward direction.

In some embodiments, the navigation controls 13 described above with respect to FIGS. 2A-2C may be configured to enable “throttling” for quickly scrolling through various menu options that may be displayed on the dispensing device 10. For example, in response to the user selecting and maintaining an engagement with the navigation control 13B of FIG. 2A, the display screen 12 may initially scroll slowly through available menu options at a first navigation rate for a predetermined time period and then scroll through any remaining available menu options at an increased navigation rate. In this manner, the user may be able to scroll through a large number of available menu options in a relatively short time period.

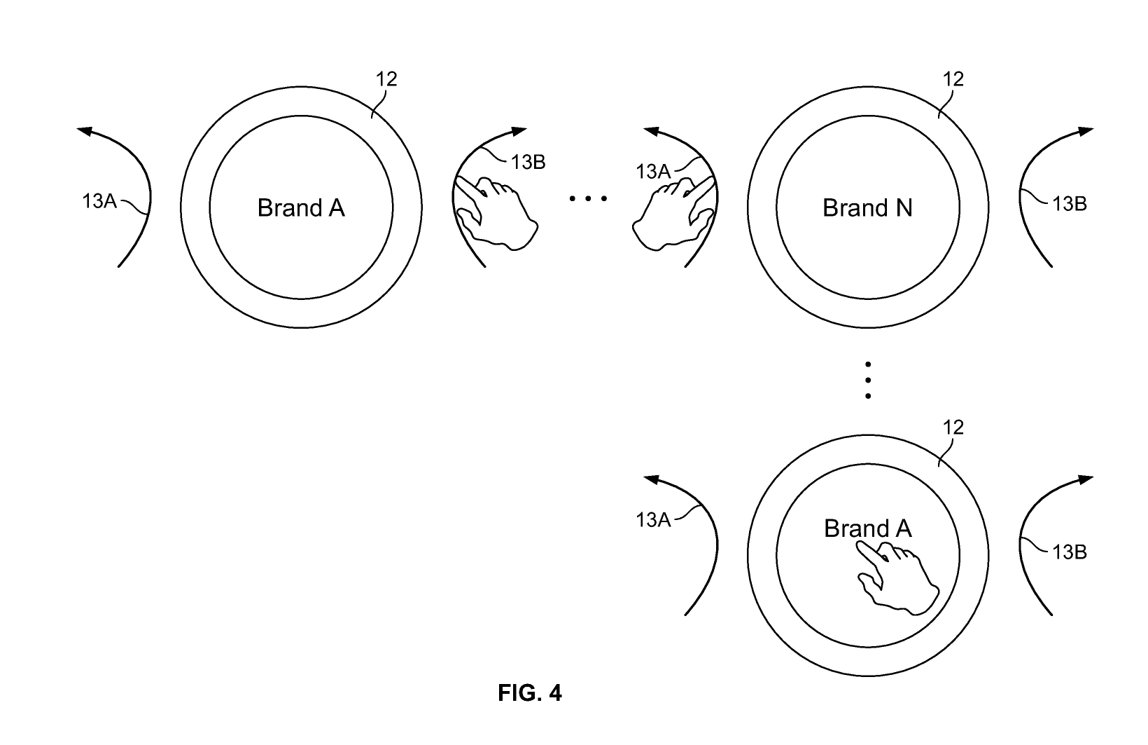

FIG. 3A shows a control interface displaying an option for selecting a product available for dispense on the dispensing device 10, in accordance with some embodiments. The control interface of FIG. 3A may include the display screen 12 (which displays a “select beverage product” option) and navigation controls 13A and 13B. In some embodiments, the “select beverage product” option may be displayed in response to the user selecting the navigation control 13B (e.g., see FIG. 2A) when the dispenser control menu is shown on the display screen 12. As will be described in greater detail below with respect to FIG. 4, upon the “select beverage product” option being displayed, the display screen 12 may then be actuated by the user to view a first available beverage product brand for dispense from the dispensing device 10.

FIG. 3B shows a control interface displaying an option for initializing the dispensing device 10, in accordance with some embodiments. The control interface of FIG. 3B may include the display screen 12 (which displays an “initialize dispenser” option) and navigation controls 13A and 13B. In some embodiments, the “initialize dispenser” option may be displayed in response to the user selecting the navigation control 13B (e.g., see FIG. 3A) when the “select beverage product” option is shown on the display screen 12. In some embodiments, the display screen 12 may be actuated by the user to display additional options associated with initializing the dispensing device 10. As discussed above, these options may include setting up the dispensing device 10 to dispense various beverage products. For example, initialization options, that may be further displayed, may include instructions for installing a CO₂ canister in the dispensing device 10, installing a filter in a dispensing device reservoir tank, filling the reservoir tank with ice and water and installing an ingredient package (e.g., a pouch) into the dispensing device 10, and priming the dispensing device 10 for dispense. Other initialization options may include selecting a setup language, calendar, clock, and Wi-Fi functionality associated with the dispensing device 10. Each of the aforementioned options may be individually displayed and selected using the navigation control 13 and the selectable display screen 12.

FIG. 3C shows a control interface displaying an option for initiating a change out of a product brand in the dispensing device 10, in accordance with some embodiments. The control interface of FIG. 3C may include the display screen 12 (which displays a “brand change out” option) and navigation controls 13A and 13B. In some embodiments, the “brand change out” option may be displayed in response to the user selecting the navigation control 13B (e.g., see FIG. 3B) when the “initialize dispenser” option is shown on the display screen 12. In some embodiments, the display screen 12 may be actuated by the user to display additional options associated with changing out a product brand ingredient package in the dispensing device 10. These options may include prompting the user as to whether they wish to insert a new or used ingredient package, prompting the user to insert a flushing pouch and for an input to flush the dispensing device 10, prompting the user to insert the ingredient package to change out the product brand and prompting the user for an input to prime the dispensing device 10. Each of the aforementioned options may be individually displayed and selected using the navigation control 13 and the selectable display screen 12.

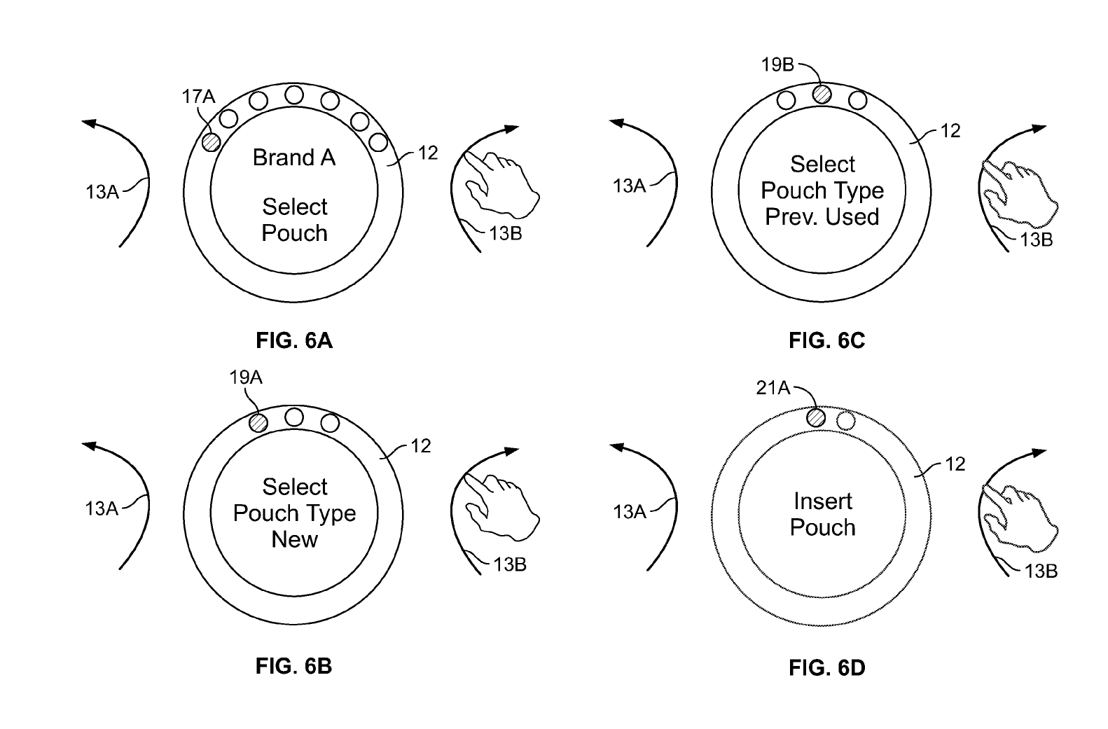

FIG. 3D shows a control interface displaying an option for replacing a product ingredient package in the dispensing device 10, in accordance with some embodiments. The control interface of FIG. 3D may include the display screen 12 (which displays a “replace ingredient package” option) and navigation controls 13A and 13B. In some embodiments, the “replace ingredient package” option may be displayed in response to the user selecting the navigation control 13B (e.g., see FIG. 3C) when the “brand change out” option is shown on the display screen 12. As will be described in greater detail below with respect to FIGS. 6A-6E, upon the “replace ingredient package” option being displayed, the display screen 12 may then be actuated by the user to display additional options associated with replacing an ingredient package in the dispensing device 10. Each of the aforementioned options may be individually displayed and selected using the navigation control 13 and the selectable display screen 12.

FIG. 3E shows a control interface displaying an option for initiating a change out of a product brand in the dispensing device 10, in accordance with some embodiments. The control interface of FIG. 3E may include the display screen 12 (which displays a utilities option) and navigation controls 13A and 13B. In some embodiments, the utilities option may be displayed in response to the user selecting the navigation control 13B (e.g., see FIG. 3D) when the “replace ingredient package” option is shown on the display screen 12. In some embodiments, the utilities option may be displayed in response to the user actuating the display screen 12 when the display screen 12 shows a beverage product for dispense from the dispensing device 10. The display screen 12 in the control interface of the dispensing device 10 may further includes option identifiers 17A-17E that may each represent additional options accessible from the currently displayed utilities option upon actuation of the display screen 12. Additional utilities options may include many of the options discussed above with respect to FIG. 3B regarding the “initialize dispenser” option (e.g., changing a language preference and setting calendar and clock functions) as well as the following additional options: displaying a remaining filter life, prompting for an input to reset a filter, prompting for an input for turning an “energy saving” mode on or off, and prompting to check for available software updates (e.g., for download via Wi-Fi). Each of the aforementioned options may be individually displayed and selected using the navigation control 13 and the display screen 12.

FIG. 4 shows a control interface for selecting from among a number of available products in the dispensing device 10 for dispense, in accordance with some embodiments. As shown in FIG. 4, the navigation controls 13A and 13B may be selected by user to scroll through a series of available beverage product brands (e.g., Brands A-N) on the display screen 12. In some embodiments, the series of available beverage product brands may include a predetermined number of “core” beverages and flavored versions of the core beverages. Thus, for example, following the display of a core beverage, subsequent options may include the display of flavored versions of the previously displayed core beverage prior to displaying a different core beverage. Available beverage product brands may also include, but are not limited to, carbonated water, flavored carbonated water, still, or sparkling water, and flavored still or sparkling water. In some embodiments, once a desired beverage product is displayed on the display screen 12, the user may initiate pouring of the beverage product by actuating the pour mechanism 37 described above with respect to FIG. 1. In some embodiments, the functionality of the pour mechanism 37 may be integrated into the display screen 12 such that the user may initiate the pouring of a desired beverage product by actuating the display screen 12 itself.

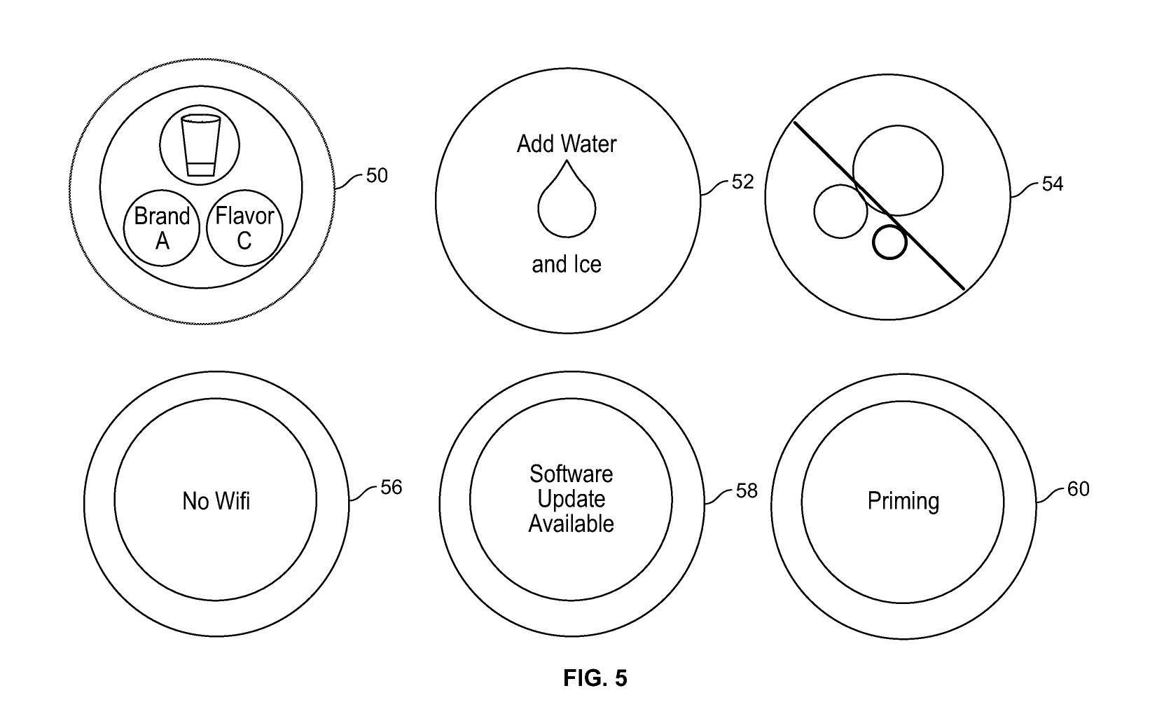

FIG. 5 shows various alerts that may be generated by a dispenser control interface, in accordance with some embodiments. The control interface in the dispensing device 10 may be configured to display various alerts in the display screen 12 upon the occurrence of certain conditions. In particular, the application 35 executing on the dispensing device 10 may be configured to track the status of various ingredients utilized by installed ingredient packages including low core brand supply levels, low flavor supply levels, low water and ice supply levels and low carbonated water supply levels. Upon the occurrence the aforementioned conditions, the control interface may be configured to display alerts 50, 52 and 54, respectively, on the display screen 12. In some embodiments, low core brand supply and low flavor supply alerts (or a combination of the two) may be displayed as oscillating with the display of a corresponding beverage product upon scrolling to the beverage product on the display screen 12 using the navigation control 13. Thus, the alert 50 may be generated when there is a low supply of a flavored core beverage comprising Brand A and Flavor C. Other alerts, that may be displayed by the control interface in the dispensing device 10, may include a loss of network connectivity alert 56 (e.g., “No Wi-Fi”), a software update alert 58, and a priming alert 60. Other alerts may also be displayed.

FIGS. 6A-6D show a control interface that may be utilized to perform a product change out in the dispensing device 10, in accordance with some embodiments. As shown in FIG. 6A, a control interface is shown that may include the display screen 12 (which displays a “select pouch” option) and navigation controls 13A and 13B. The display screen 12 may also include option identifier 17A that represents the beverage product (i.e., “Brand A”) that has been selected for replacement in the dispensing device 10. The navigation controls 13A and 13B may be utilized to scroll through additional beverage products for performing a product change out.

FIGS. 6B-6C show options that may be presented to the user by the control interface after the display screen 12 has been actuated to select beverage product “Brand A” for product change out. For example, in FIG. 6B the option identifier 19A on the display screen 12 is selected to indicate that a new beverage product (i.e., “select pouch type new”) will be used to replace a previously inserted beverage product in the dispensing device 10 by the user. Similarly, in FIG. 6C the option identifier 19B on the display screen 12 is selected to indicate that a previously used beverage product (i.e., “select pouch type prev. used”) will be used to replace a previously inserted beverage product in the dispensing device 10 by the user. The navigation controls 13A and 13B may be utilized to scroll through the option identifiers 19A and 19B so that the user may specify whether a new or previously used beverage product will be used to replace a previously removed beverage product in the dispensing device 10.

FIG. 6D may show an option presented to the user by the control interface after the display screen 12 has been actuated to select a new or previously used beverage product in the dispensing device 10. As shown in FIG. 6D, the option identifier 21A is selected to display an “insert pouch” option that may serve as a prompt to the user to insert a replacement beverage product (e.g., an ingredient package) in a corresponding slot in the dispensing device 10. In some embodiments, following a determination by the dispensing device 10 that the replacement beverage product has been inserted, the control interface may be configured to return to the dispenser control menu described above with respect to FIGS. 2A-2C.

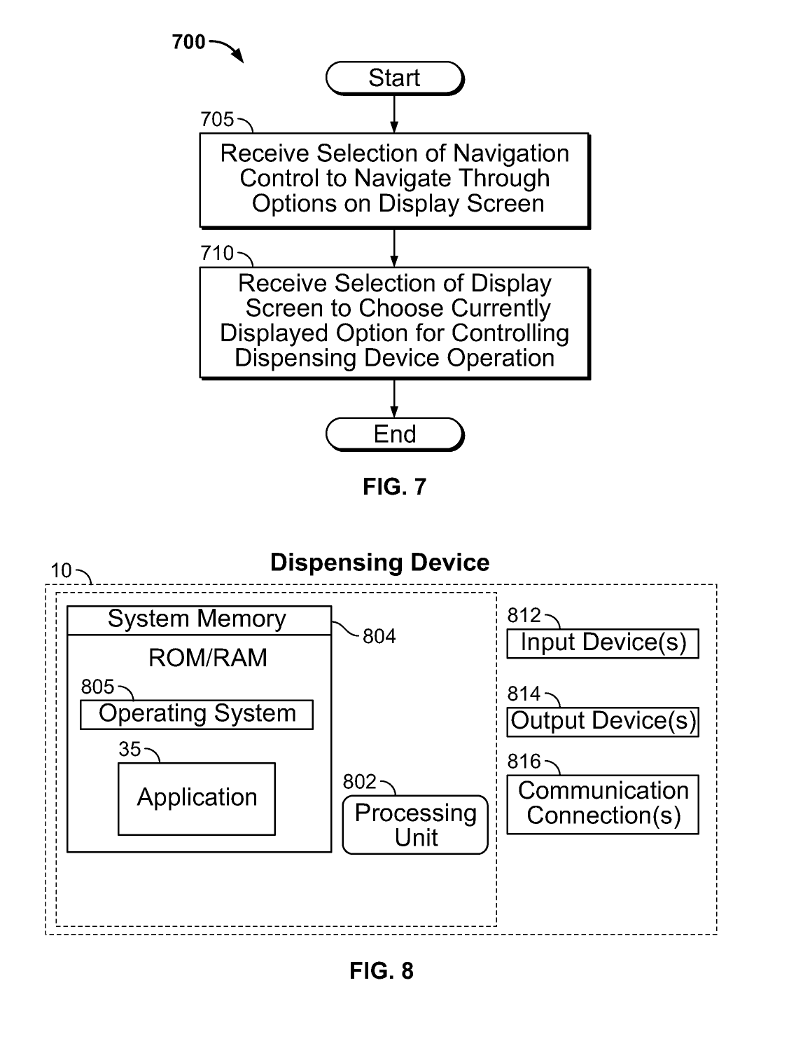

FIG. 7 is a flow diagram illustrating a routine 700 for controlling a dispensing device utilizing a control interface, in accordance with some embodiments. The logical operations of various embodiments may be implemented (1) as a sequence of computer implemented acts or program modules running on a computing device or system and/or (2) as interconnected machine logical circuits or circuit modules within the computing device or system. The implementation is a matter of choice dependent on the performance requirements of the computing device or system implementing some embodiments. Accordingly, the logical operations illustrated in FIG. 7 and making up the embodiments described herein are referred to variously as operations, structural devices, acts or modules. These operations, structural devices, acts and modules may be implemented in software, in firmware, in hardware, in special purpose digital logical, and any combination thereof.

The routine 700 begins at operation 705, where the application 35 executing on the dispensing device 10, may receive a selection of a navigation control to individually navigate through each of a number of selectable options on the display screen 12. The display screen 12 may comprise a predefined area for individually presenting each of the number of selectable options. In some embodiments, the number of selectable options may include a main menu and a number of sub-menus. Each of the sub-menus may be associated with one or more operations for controlling the dispensing device 10. The number of selectable options may include the selection of a beverage product for dispense, a beverage product change out operation, one or more dispensing device settings, and a dispensing device initialization. In some embodiments, the user may navigate through a first set of the number of selectable options at a first navigation rate for a predetermined time period and navigate through another set of the number of selectable options at a second navigation rate upon expiration of the predetermined time period, wherein the second navigation rate is greater than the first navigation rate. In some embodiments, the navigation control may be a rotational control such as a physical control knob or alternatively the user interface element (e.g., a touch interface).

From operation 705, the routine 700 continues to operation 710, where the application 35 executing on the dispensing device 10 may receive a selection of the display screen 12 to choose a currently displayed one of the number of options. In some embodiments, the display screen 12 may include comprise a mechanical switch. In some embodiments, the display screen 12 may comprise a touchscreen. From operation 710, the routine 700 then ends.

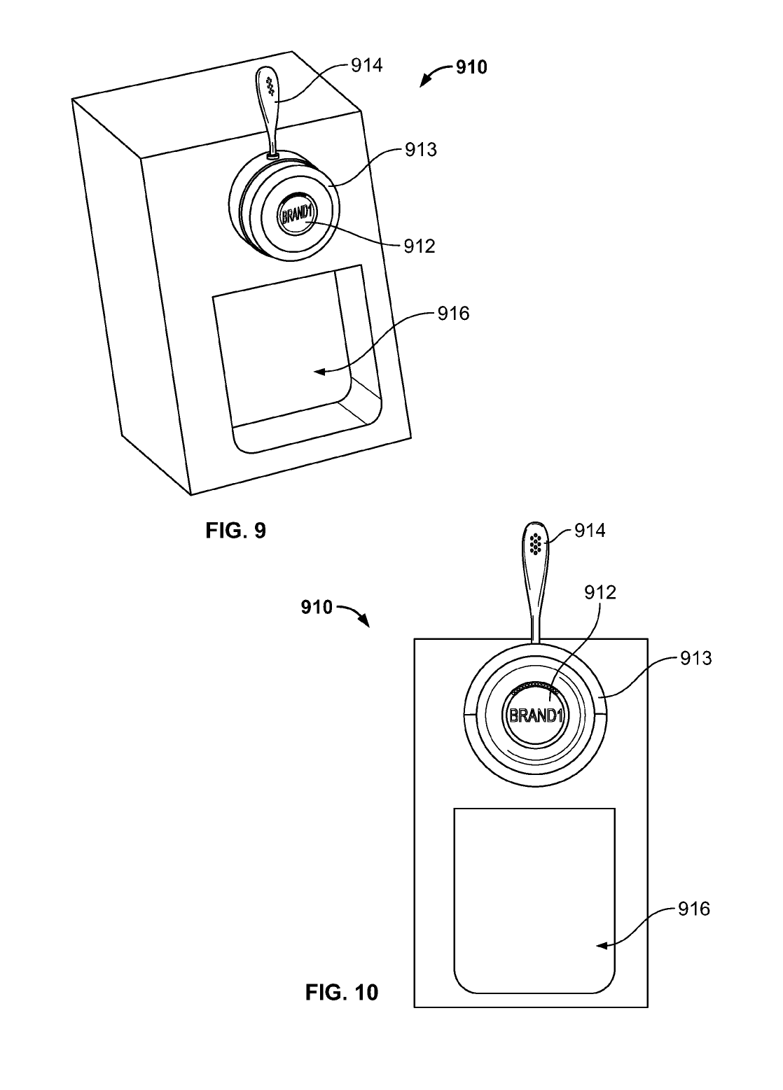

FIG. 8 is a block diagram of a dispensing device with which some embodiments may be practiced. In a basic configuration, the dispensing device 10 may comprise a computing device that includes at least one processing unit 802 and a system memory 804. The system memory 804 may comprise, but is not limited to, volatile (e.g. random access memory (RAM)), non-volatile (e.g. read-only memory (ROM)), flash memory, or any combination. System memory 804 may include an operating system 805 and the application 35. The operating system 805 may control the dispensing device 10's operation.

The dispensing device 10 may have additional features or functionality. For example, the dispensing device 10 may also include additional data storage devices (not shown) that may be removable and/or non-removable such as, for example, magnetic disks, optical disks, solid state storage devices (“SSD”), flash memory or tape. The dispensing device 10 may also have input device(s) 812 such as a keyboard, a mouse, a pen, a sound input device (e.g., a microphone), a touch input device, control knob input device, etc. Output device(s) 814 such as a touchscreen display, speakers, a printer, etc. may also be included. The aforementioned devices are examples and others may be used. Communication connection(s) 816 may also be included and utilized to connect to the Internet (or other types of networks) as well as to remote computing systems.

Some embodiments, for example, may be implemented as a computer process (method), a computing system, or as an article of manufacture, such as a computer program product or computer readable media. The computer program product may be a computer storage media readable by a computer system and encoding a computer program of instructions for executing a computer process.

Computer readable media, as used herein, may include computer storage media. Computer storage media may include volatile and nonvolatile, removable and non-removable media implemented in any method or technology for storage of information (such as computer readable instructions, data structures, program modules, or other data) in hardware. The system memory 804 is an example of computer storage media (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium that can be used to store information and that can be accessed by the dispensing device 10. Any such computer storage media may also be part of the dispensing device 10. Computer storage media does not include a carrier wave or other propagated or modulated data signal.

Computer readable media, as used herein, may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. Communication media may include wired media such as a wired network or direct-wired connection, and wireless media such as acoustic, radio frequency (RF), infrared, and other wireless media.

Referring now to FIGS. 9-13, another example dispensing device 910 is shown. The dispensing device 910 is similar to the dispensing device 910 described above, with the differences noted below. The dispensing device 910 depicted is only one example of a dispensing device. Various other dispensing devices, being larger, smaller, and/or configured in differing manners, can also be provided.

The example dispensing device 910 includes a navigation control 913 and a display screen 912. The dispensing device 910 also includes an optional dispensing control 914 and a dispensing area 916 into which a cup or other receptacle can be placed to receive a beverage that is poured by the dispensing device 910.

As described further below, the navigation control 913 is used to control the various modes of operation of the dispensing device 910. The display screen 912 provides information about the current mode of operation for the dispensing device 910. In some embodiments, the display screen 912 can also accept input, for example, when the display screen 912 is a touch screen device.

In the example shown, the navigation control 913 can be rotated in both clockwise and counterclockwise directions 1101 about the display screen 912 (which can remain stationery and/or rotate with the navigation control 913). The rotation of the navigation control 913 can be accomplished by allowing the user to grasp a portion 1110 of the navigation control 913 with one or more fingers of the user's hand 1301. The rotation is performed in order to control various aspects of the operation of the dispensing device 910, such as one or more of the following modes described further below: pour mode; settings mode; warnings mode; and/or idle mode. The display screen 912 displays aspects of each of these modes as the navigation control 913 is rotated in the directions 1101.

Further, in some embodiments, the navigation control 913 includes a plurality of input members 1210, 1214 located at a bezel 1200 of the navigation control 913. These input members 1210, 1214 can be touched and/or depressed by the user to make various selections, such as selecting between the pour mode and the settings mode, and confirming an input.

For example, as depicted in FIG. 14, the navigation control 913 includes input members 1402 and 1404 that are capacitive buttons that sense the presence of the user's finger. The input member 1402 allows the user to select the pour mode, and the input member 1404 allows the user to select the settings mode. In addition, an input member 1406 is provided to allow the user to confirm a selection as shown on the display screen 912.

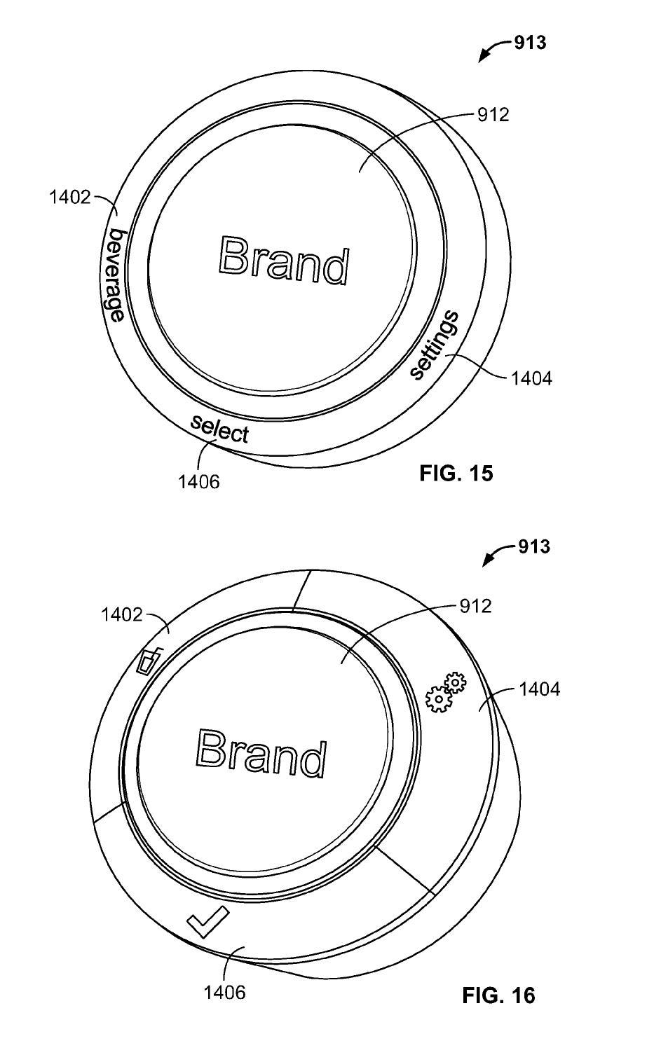

The navigation control 913 shown in FIG. 15 is similar, except the icons representing the function of each of the input members 1402, 1404, 1406 is replaced with text describing the functions (i.e., pour mode (1402), settings mode (1404), and selection (1406)).

The navigation control 913 depicted in FIG. 16 is similar, except that the input member 1402, 1404, 1406 are mechanically actuated by allowing the user's finger to depress each of the input members 1402, 1404, 1406. Other configurations are possible.

Referring again to FIGS. 9-13, the dispensing control 914 can also be used to control the dispensing device 910 such as, for example, causing the dispensing device 910 to pour a beverage when the dispensing control 914 is actuated. For example, the user can actuate the dispensing control 914 by pulling the dispensing control 914 in a direction 1201 towards the user to pour the selected beverage.

Other configurations are possible. For example, the dispensing control 914 can be configured to move in two or more directions to function as inputs to control the dispensing device 910. In yet other examples, the dispensing control 914 can be eliminated, and the navigation control 913 can be used to perform the pouring function(s).

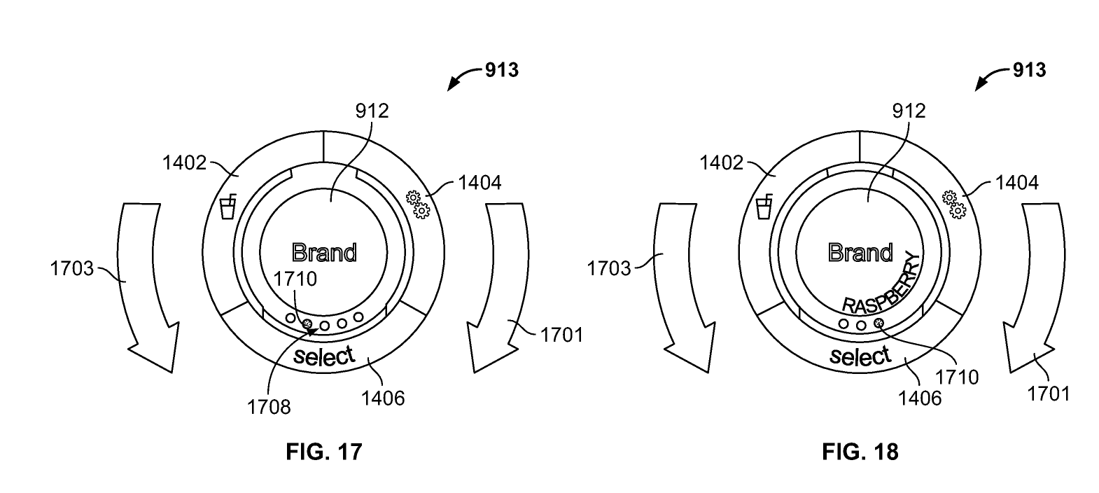

Referring now to FIGS. 17-19, one example of the navigation control 913 in use is depicted. In this example, the navigation control 913 is used to select a particular beverage for pouring.

Generally, the input member 1402 is selected by the user to access the beverage selection interface of the navigation control 913. The navigation control 913 is moveable in both a clockwise direction 1701 and a counterclockwise direction 1703 to select between the beverage brands. A plurality of identifiers 1708 are provided as the user cycles through the beverage options, with the currently-selected beverage brand shown on the display screen 912 being the highlighted identifier 1710.

In this example, when the desired beverage brand is shown on the display screen 912, the user actuates the input member 1406 to select that beverage brand. In an alternative embodiment, the navigation control 913 is programmed to automatically select the currently-displayed brand on the display screen 912 after a certain period of time elapses without input from the user on the navigation control 913. Other configurations are possible.

As shown in FIG. 18, at that point, the display screen 912 is modified to show beverage sub-brands, beverage flavors, and/or beverage additives associated with the selected brand that can be selected by the user by rotating the navigation control 913 in the directions 1701, 1703 until the desired beverage sub-brand is shown on the display screen 912. The user then selects the input member 1406 to select that beverage sub-brand. The user can select the input member 1402 to return to the beverage brand selection at any point, if desired.

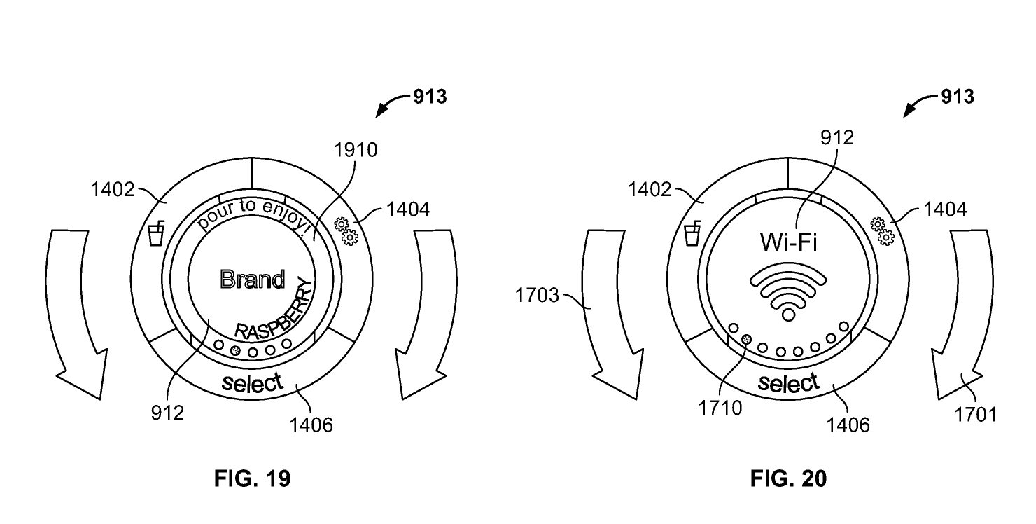

As shown in FIG. 19, after selection of the beverage sub-brand, flavor, and/or additive, the display screen 912 provides an indicator 1910 that shows that the beverage is ready for pouring. The user can thereupon dispense the beverage by, for example, actuating the dispensing control 914 and/or by depressing a pour button located on the navigation control 913 or elsewhere.

In alternative embodiments, the navigation control 913 can be configured in other manners. For example, the navigation control 913 can be configured to allow the user to select among beverage brands by rotating in one direction (e.g., clockwise direction 1701), and thereupon select among beverage sub-brands by rotating in another direction (e.g., counterclockwise direction 1702). Other configurations are possible.

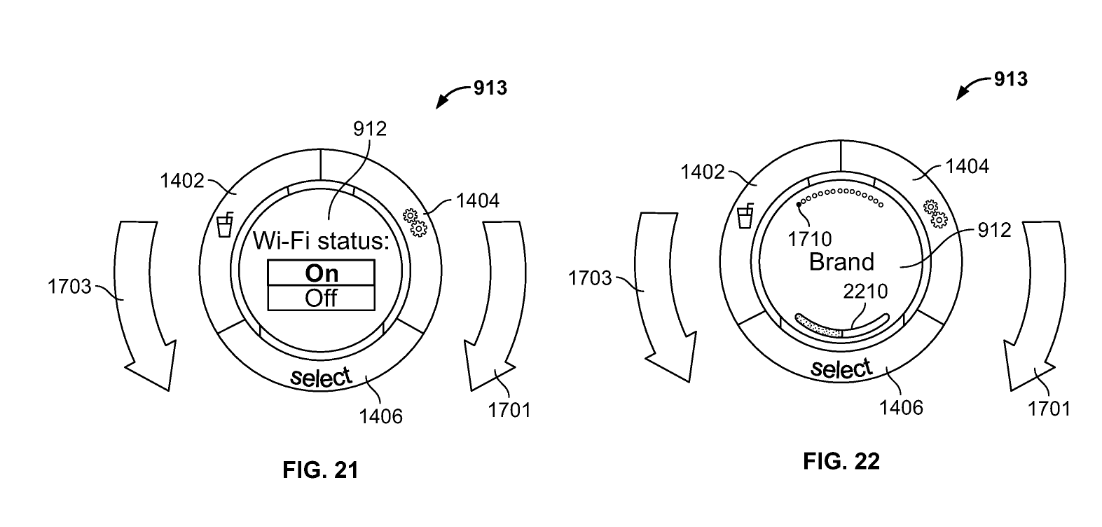

Referring now to FIGS. 20-21, the user can utilize the navigation control 913 to control other functions of the dispensing device 910, such as settings. In this example, the user can select the input member 1404 to access the settings mode. The user can thereupon rotate the navigation control 913 in the directions 1701, 1703 to select among the different settings for the dispensing device 910. In the example shown in FIG. 20, the navigation control 913 is rotated to the Wi-Fi setting.

The user has then selected the input member 1406 to access the Wi-Fi settings shown in FIG. 21. The display screen 912 displays the status of the Wi-Fi (“On” or “Off”) and allows the user to toggle the Wi-Fi status. This can be accomplished by the user rotating the navigation control 913 so that the “On” and “Off” options are sequentially highlighted on the display screen 912. When the desired option is selected, the user can access the input member 1406 to select the desired option. The user can select input members 1402, 1404 at any point to return to the pour mode or settings mode.

Referring now to FIG. 22, another example of the navigation control 913 is shown. This navigation control 913 is similar to that described above, except the display screen 912 provides a supply-level indicator 2210. This supply-level indicator 2210 is a visual depiction of a supply level associated with the beverage that is remaining in the dispensing device 910. For example, the supply-level indicator 2210 is depicted as a curved bar graph. As the ingredient(s) to make the beverage shown on the display screen 912 are depleted, the bar on the supply-level indicator 2210 recedes to provide a visualization of the remaining amount of the selected beverage. This can be an optional feature that could be turned on or off by the user as desired. Other configurations are possible. For example, the supply-level indicator 2210 could also be a numeric indicator (e.g., providing a numerical percentage left) and/or a colored visual indicator (e.g., color-coded green, yellow, and red).

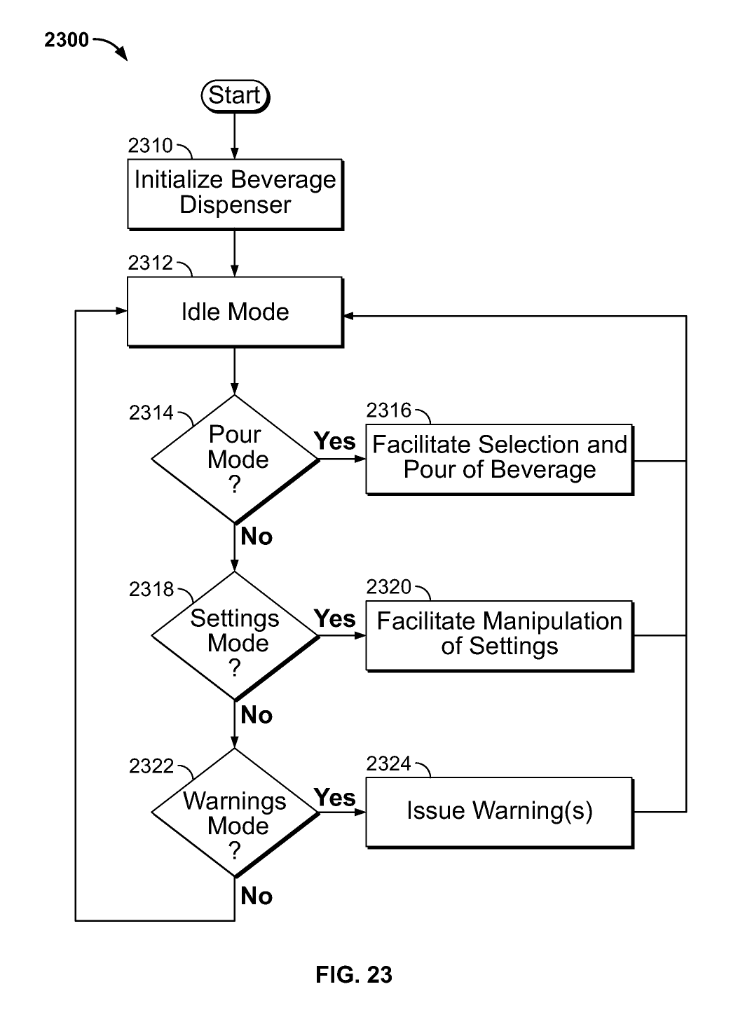

Referring now to FIG. 23, an example method 2300 of use for the dispensing device 910 is shown. The method 2300 is facilitated by using the navigation control 913 to control the dispensing device 910.

The method 2300 starts at operation 2310 when the dispensing device 910 is turned on. Upon startup, the dispensing device 910 enters an initialization mode. As discussed above, various attributes of the dispensing device 910 can be controlled by the navigation control 913 during initialization. These attributes can include, for example, options to initialize the dispensing device 910 to dispense various beverage products, as well as setup language, calendar, clock, and Wi-Fi functionality associated with the dispensing device 910.

After initialization of the dispensing device 910, control is passed to operation 2312, whereat the dispensing device 910 remains in an idle mode until further input is provided. In the idle mode, the dispensing device 910 can enter a low power (i.e., energy saving) state while waiting for input from the user through the navigation control 913. This input can be selection by the user of one or more of the pour mode or settings mode using the navigation control 913.

For example, control is passed to operation 2314, and the dispensing device 910 determines if the pour mode has been selected by the user. This can be done, for example, by the user selecting the input member 1402 and/or rotating the navigation control 913 to select a beverage for pouring.

If the dispensing device 910 senses this input from the user, control is passed to operation 2316, and the dispensing device 910 accepts input from the navigation control 913 as the user selects and pours a beverage, such as is described above. Control is then passed back to operation 2312, and the dispensing device 910 resumes the idle mode.

If the pour mode is not selected, control is instead passed from operation 2314 to 2318, and the dispensing device 910 determines if the user has selected the settings mode. This can be done, for example, by the user selecting the input member 1404 and/or rotating the navigation control 913 to select a particular setting of the dispensing device 910.

If the dispensing device 910 senses this input from the user, control is passed to operation 2320, and the dispensing device 910 accepts input from the navigation control 913 as the user manipulates one or more settings of the dispensing device 910.

In example embodiments, the user can rotate the navigation control 913 to select among the following settings for the dispensing device 910: Wi-Fi (see FIGS. 20-21), dispenser calibration, energy savings mode, beverage pouch change, dispenser cleaning (e.g., carbonator or syrup dispenser), and/or replace water filter. Aspects of some of these settings have been described above.

By selecting one of these settings using the navigation control 913, the user can be presented with information about the setting on the display screen 912. The user can manipulate some of the settings, such as the Wi-Fi setting shown in FIGS. 20-21. For other settings, the user can be presented with a “wizard” interface on the display screen 912 that walks the user through various tasks associated with the dispensing device 910, such as how to replace a beverage pouch or water filter.

For example, when replacing some beverage pouches, it may be desirable to track a volume of a particular beverage ingredient used. This can be accomplished by using the navigation control 913 to input an identifier (e.g., package code) associated with a pouch when the pouch is replaced within the dispensing device 910.

In yet other examples, the navigation control 913 can be used to provide other input to the dispensing device 910, such as through other input methods like a virtual keyboard that is displayed upon the display screen 912 and manipulated by rotating the navigation control 913. For example, the keyboard can be a circular keyboard that allows for user input by rotating the navigation control 913 to select one or more of the letters/numbers/symbols on the keyboard. Upon selection of a character, the dispensing device 910 can display the character on the display screen 912 and move the cursor to the next input position. Other configurations are possible.

Once the desired settings have been manipulated by the user using the navigation control 913, control is then passed back to operation 2312, and the dispensing device 910 resumes the idle mode.

If the settings mode is not selected, control is instead passed from operation 2318 to 2322, and the dispensing device 910 issues any warnings associated with the operation of the dispensing device 910. If warnings do exist, control is passed to operation 2324.

Various warnings can be provided. For example, if the carbon dioxide is low or runs out, the dispensing device 910 can disable the pour mode and issue an alert to the issue, such as by providing information about the warning on the display screen 912. Similarly, a warning can be provided if no water is present, and dispensing of water in the pour mode can be disabled. Further information, such as how to refill any water reservoir (if provided) associated with the dispensing device 910, can also be provided on the display screen 912.

Further, alerts can be provided that are associated with the ingredients for the beverages, such as when a beverage and/or ingredient is low. These alerts can be potentially dismissed by the user for a period of time or until any low warnings become warnings about exhausted ingredients. Alarms about other replacement components, such as a water filter, can also be provided along with information on how to replace the component.

After any warnings are issued (or no warnings exist), control is passed back to operation 2312, and the dispensing device 910 resumes the idle mode.

In some examples, the dispensing device 910 can be programmed to revert back to a given operating mode (e.g., the idle mode) after a certain timeout period. For example, when in operation 2316 (pour mode) or operation 2320 (settings mode), the dispensing device can be programmed to revert to the idle mode if the user fails to provide input through the navigation control 913 within a given time period.

Some embodiments are described above with reference to block diagrams and/or operational illustrations of methods, systems, and computer program products. The operations/acts noted in the blocks may be skipped or occur out of the order as shown in any flow diagram. For example, two or more blocks shown in succession may in fact be executed substantially concurrently or the blocks may sometimes be executed in the reverse order, depending upon the functionality/acts involved.

Although various embodiments have been described in connection with various illustrative examples, many modifications may be made thereto within the scope of the claims that follow. Accordingly, it is not intended that the scope of the embodiments in any way be limited by the above description, but instead be determined entirely by reference to the claims that follow.

What is claimed is:

1. A dispensing device comprising:
a display screen for individually presenting each of a plurality of selectable options, the plurality of selectable options being utilized for controlling a plurality of operations associated with the dispensing device; and
a navigation control, in communication with the display screen, the navigation control being utilized to individually navigate through each of the plurality of selectable options.

2. The dispensing device of claim 1, wherein the plurality of selectable options comprises a main menu and a plurality of sub-menus, each of the plurality of sub-menus being associated with a subset of the plurality of selectable options, the subset of the plurality of selectable options being utilized for controlling the plurality of operations.

3. The dispensing device of claim 1, wherein the plurality of selectable options comprises a selection of a beverage product for dispense, a beverage product change out operation, one or more dispensing device settings, and a dispensing device initialization.

4. The dispensing device of claim 1, wherein the navigation control navigates through a first set of the plurality of selectable options at a first navigation rate for a predetermined time period and navigates through another set of the plurality of selectable options at a second navigation rate upon expiration of the predetermined time period, wherein the second navigation rate is greater than the first navigation rate.

5. The dispensing device of claim 1, wherein the navigation control comprises a rotational control for individually navigating through each of the plurality of selectable options.

6. The dispensing device of claim 5, wherein the rotational control comprises a control knob for individually navigating through each of the plurality of selectable options.

7. The dispensing device of claim 5, wherein the rotational control comprises a user interface element for individually navigating through each of the plurality of selectable options.

8. The dispensing device of claim 1, wherein the display screen comprises a mechanical switch for selecting the plurality of selectable options.

9. The dispensing device of claim 1, wherein the display screen comprises a touch interface for selecting the plurality of selectable options.

10. A beverage dispensing device comprising:
a display screen for individually presenting each of a plurality of selectable options, the plurality of selectable options being utilized for controlling a plurality of operations associated with the beverage dispensing device; and
a navigation control, in communication with the display screen, the navigation control being utilized to individually navigate through each of the plurality of selectable options, wherein the navigation control navigates through a first set of the plurality of selectable options at a first navigation rate for a predetermined time period and navigates through another set of the plurality of selectable options at a second navigation rate upon expiration of the predetermined time period, wherein the second navigation rate is greater than the first navigation rate.

11. The beverage dispensing device of claim 10, wherein the plurality of selectable options comprises a main menu and a plurality of sub-menus, each of the plurality of sub-menus being associated with a subset of the plurality of selectable options, the subset of the plurality of selectable options being utilized for controlling the plurality of operations associated with the beverage dispensing device.

12. The beverage dispensing device of claim 10, wherein the navigation control comprises a rotational control for individually navigating through each of the plurality of selectable options.

13. The beverage dispensing device of claim 12, wherein the rotational control comprises a control knob for individually navigating through each of the plurality of selectable options.

14. The beverage dispensing device of claim 10, wherein the display screen comprises a mechanical switch for selecting the plurality of selectable options.

15. A method of controlling a dispensing device utilizing a control interface, comprising:
receiving, on the dispensing device, a selection of a navigation control to individually navigate through each of a plurality of selectable options on a display screen associated with the dispensing device, the display screen comprising a predefined area for individually presenting each of the plurality of selectable options; and
receiving a selection of the display screen to choose a currently displayed one of the plurality of selectable options, the plurality of selectable options being utilized for controlling a plurality of operations associated with the dispensing device.

16. The method of claim 15, wherein receiving, on the dispensing device the selection of the navigation control to individually navigate through each of the plurality of selectable options on a display screen associated with the dispensing device further comprises navigating through a first set of the plurality of selectable options at a first navigation rate for a predetermined time period and navigating through another set of the plurality of selectable options at a second navigation rate upon expiration of the predetermined time period, wherein the second navigation rate is greater than the first navigation rate.

17. The method of claim 15, wherein receiving, on the dispensing device the selection of the navigation control to individually navigate through each of the plurality of selectable options on a display screen associated with the dispensing device comprises receiving a selection of a rotational control.

18. The method of claim 15, wherein receiving a selection of a rotational control comprises receiving a selection of a control knob.

19. The method of claim 15, wherein receiving a selection of a rotational control comprises receiving a selection of a user interface element.

20. The method of claim 15, wherein receiving a selection of the display screen to choose a currently displayed one of the plurality of selectable options, comprises receiving a selection of a mechanical switch.

21. The method of claim 15, wherein receiving a selection of the display screen to choose a currently displayed one of the plurality of selectable options, comprises receiving a selection of a touchscreen.

22. The method of claim 15, wherein the plurality of selectable options comprises a main menu and a plurality of sub-menus, each of the plurality of sub-menus being associated with one or more of the plurality of operations.

23. The method of claim 15, wherein the plurality of selectable options comprises a selection of a beverage product for dispense, a beverage product change out operation, one or more dispensing device settings, and a dispensing device initialization.
